(19) United States
(12) Patent Application Publication
(10) Pub. No.: US 2024/0269833 A1
(43) Pub. Date: Aug. 15, 2024

(54) CONTROLLING AND/OR MONITORING A ROBOT APPLICATION

(71) Applicant: KUKA Deutschland GmbH, Augsburg (DE)

(72) Inventor: GUGLIELMO VAN DE MEER, Augsburg (DE)

(73) Assignee: KUKA Deutschland GmbH, Augsburg (DE)

(21) Appl. No.: 18/569,104

(22) PCT Filed: May 13, 2022
(86) PCT No.: PCT/EP2022/062997

§ 371 Date: Dec. 11, 2023

(30) Foreign Application Priority Data
Jun. 18, 2021 (DE) 10 2021 206 254.7

(51) Int. Cl. B25J 9/16; G05B 19/4155

(52) U.S. Cl. CPC B25J 9/1628; G05B 19/4155; G05B 2219/50391

(57) ABSTRACT

A method for controlling and/or monitoring a robot application includes determining a time series of first output data values on the basis of a time series of first input data values, a time series of second input data values, a time series of property changes of the first input data values and property changes of the second input data values relative to one another, and a predefined first link of the first and second input data values with the output data values that includes a predefined temporal target sequence of property changes of the first input data values and property changes of the second input data values relative to one another. The method further includes controlling and/or monitoring the robot application on the basis of the determined first output data values.

### CROSS-REFERENCE TO RELATED APPLICATIONS

This application is a national phase application under 35 U.S.C. § 371 of International Patent Application No. PCT/EP2022/062997, filed May 13, 2022 (pending), which claims the benefit of priority to German Patent Application No. DE 10 2021 206 254.7, filed Jun. 18, 2021, the disclosures of which are incorporated by reference herein in their entirety.

### TECHNICAL FIELD

The present invention relates to a method for controlling and/or monitoring a robot application, a programming library, and a method for creating a program for controlling and/or monitoring a robot application, and a system, computer program, and computer program product for carrying out one of these methods.

### SUMMARY

An object of one embodiment of the present invention is to improve the controlling and/or monitoring of robot applications and/or the creation of a program for this purpose.

This object is achieved by a method; and a programming library, a system, and a computer program or computer program product for performing a method as described herein.

According to one embodiment of the present invention, a method for controlling and/or monitoring a robot application comprises the steps:
determining a time series of first output data values on the basis of
a time series of first input data values,
a time series of second input data values,
a time sequence of
property changes of the first input data values and
property changes of the second input data values

relative to one another, and
a predetermined first linkage, in particular mapping, of the first and second input data values to the output data values, in particular to the output data values, wherein the linkage comprises a predetermined temporal target sequence of property changes of the first input data values and property changes of the second input data values relative to one another, in particular the mapping being a mapping based on a predetermined temporal target sequence of property changes of the first input data values and property changes of the second input data values relative to one another; and
controlling and/or monitoring the robot application on the basis of the determined first output data values.

By specifying a temporal target sequence of property changes of first input data values and property changes of second input data values relative to one another, a determination of (first) output data values on the basis of an actual or current sequence of property changes of first input data values and property changes of second input data values relative to one another and the temporal target sequence specified for this purpose, and a control and/or monitoring of a robot application on the basis of these determined (first) output data values, in one embodiment, a (more) complex robot application can be controlled or monitored, and/or controlling and/or monitoring a robot application, in particular a complex robot application, can be improved, in particular precision, flexibility and/or safety can be increased.

In one embodiment, the method comprises the step of:
determining a time series of second output data values on the basis of a time series of third input data values and a predefined second link, in particular mapping, of the third input data values with the, in particular, to the second output data value(s);

wherein the robot application is controlled and/or monitored on the basis of the determined second output data values.

In one embodiment, the first input data values are determined directly or indirectly on the basis of the second output data values; in another embodiment, the third input data values are determined directly or indirectly on the basis of the first output data values.

In one embodiment, a (still) more complex robot application can thereby be controlled or monitored, and/or controlling and/or monitoring an in particular complex robot application can be (further) improved, in particular precision, flexibility, and/or safety can be (further) increased.

In one embodiment, a first process is carried out or stopped, or a first monitoring status is determined; in one development, a monitoring signal is output if the determined first or second output data values comprise a first value, and the first process is not carried out or is not stopped; in one development, a second process is carried out instead, or a second monitoring status is determined; in one development, no monitoring signal is output if the determined first or second output data values comprise a second value. In other words, in one embodiment, the first or second output data values trigger a process or monitoring status directly or indirectly. In particular, the first or second output data values can directly trigger an output of a monitoring signal or a starting or stopping of a process of the robot application, or can be linked to further values, or can indirectly trigger an output of a monitoring signal or a starting or stopping of a process of the robot application.

In one embodiment, controlling and/or monitoring a robot application, in particular a complex robot application, can thereby be improved, in particular precision, flexibility and/or safety can be (further) increased.

In one embodiment, the first link comprises:
a filtering of the first input data values and/or the second input data values; and/or
a time integration of the first input data values and/or the second input data values; and/or
a time derivative of the first input data values and/or the second input data values; and/or
a detection of an extremum, in particular minimum or maximum, of the first input data values and/or of an extremum, in particular minimum or maximum, of the second input data values; and/or
a detection of overshooting or undershooting a limit value, in particular a sign change of the first input data values and/or the second input data values; and/or
a detection of a value change of the first input data values and/or of the second input data values.

Additionally or alternatively, in one embodiment, the second link comprises:
a filtering of the third input data values; and/or
a time integration of the third input data values; and/or
a time derivative of the third input data values; and/or
a detection of an extremum, in particular minimum or maximum, of the third input data values; and/or
a detection of overshooting or undershooting a limit value, in particular a sign change, of the third input data values; and/or
a detection of a value change of the third input data values.

In one embodiment, a (still) more complex robot application can thereby be controlled or monitored, and/or controlling and/or monitoring an in particular complex robot application can be (further) improved, in particular precision, flexibility, and/or safety can be (further) increased.

In one embodiment, the first output data values change (their value) upon an event during the robot application. Additionally or alternatively, in one embodiment, the first output data values can comprise only two values or comprise a binary value range, in one development the Boolean values “TRUE” and “FALSE,” the values “0” and “1,” the values “ON” and “OFF” or the like.

In addition or alternatively, the second output data values change (their value) upon an event during the robot application. Additionally or alternatively, in one embodiment, the second output data values can comprise only two values or comprise a binary value range, in one development the Boolean values “TRUE” and “FALSE,” the values “0” and “1,” the values “ON” and “OFF” or the like.

In addition or alternatively, the first input data values change (their value) upon an event during the robot application. Additionally or alternatively, in one embodiment, the first input data values can comprise only two values or comprise a binary value range, in one development the Boolean values “TRUE” and “FALSE,” the values “0” and “1,” the values “ON” and “OFF” or the like.

In another embodiment, the first input data values are a signal from the robot application, acquired and/or signal-processed in one embodiment. Additionally or alternatively, in one embodiment, the first input data values can comprise more than two values, or comprise a value range having more than two values, in one development a continuous and/or real value range, in one embodiment a value range having at least ten different real values.

In addition or alternatively, the second input data values change (their value) upon an event during the robot application. Additionally or alternatively, in one embodiment, the second input data values can comprise only two values or comprise a binary value range, in one development the Boolean values “TRUE” and “FALSE,” the values “0” and “1,” the values “ON” and “OFF” or the like.

In another embodiment, the second input data values are a signal from the robot application, acquired and/or signal-processed in one embodiment. Additionally or alternatively, in one embodiment, the second input data values can comprise more than two values, or comprise a value range having more than two values, in one development a continuous and/or real value range, in one embodiment a value range having at least ten different real values.

In addition or alternatively, the third input data values change (their value) upon an event during the robot application. Additionally or alternatively, in one embodiment, the third input data values can comprise only two values or comprise a binary value range, in one development the Boolean values “TRUE” and “FALSE,” the values “0” and “1,” the values “ON” and “OFF” or the like.

In another embodiment, the third input data values are a signal from the robot application, acquired and/or signal-processed in one embodiment. Additionally or alternatively, in one embodiment, the third input data values can comprise more than two values or comprise a value range having more than two values, in one development a continuous and/or real value range, in one embodiment a value range having at least ten different real values.

In one embodiment, sensor signals from the robot application that have been recorded and/or further processed or signal-processed can be advantageously used to control or monitor the robot application by means of input or output data of more than two values.

In one embodiment, events that occur during the robot application can be advantageously recorded using two-value input or output data and used to control or monitor the robot application, or the robot application can be controlled or monitored on the basis of such events.

In one embodiment, on the one hand, time series of data values are used, in particular used as input data or determined as output data which are detected and/or further or signal-processed sensor signals of the robot application, and on the other hand time series of data values are used, in particular used as input data or determined as output data which change (their value) upon events during the robot application, in particular encode the start, the end, the duration and/or the non-existence of an event, which may be complex or multifactorial.

A program for controlling and/or monitoring a robot application according to one embodiment of the present invention can therefore in particular comprise the following links or program components or modules:

1) one or more different signal processing links or signal processing program components or signal processing program modules which comprises as input at least one time series of real, more than two value input data values or acquired and/or further or signal-processed sensor signals of the robot application, and comprises as output at least one time series of real, more than two value output data values or further or signal-processed sensor signals, in a further development:
one or more high-pass filters, low-pass filters, bandpass filters;
one or more first or higher time derivatives;
a single or multiple time integration;
a collection of a predeterminable, in particular predetermined, number of data values; and/or
a transformation into the frequency domain

or the like:

2) one or more different event detection links or event detection program components or event detection program modules which have as input at least one time series of real, more than two value input data values or acquired and/or further or signal-processed sensor signals of the robot application, and have as output at least one time series of two value output data values or events or output data values changing with events, in a further development changes the value of the output data values or thereby detects or outputs an event if:
the input data values comprise a local minimum;
the input data values comprise a local maximum;
the input data values comprise a local minimum since a reset event which is determined by a value change in a time series of two-value input signals;
the input data values comprise a local maximum since a reset event which is determined by a value change in a time series of two-value input signals;
the input data values exceed or fall below a predeterminable, in particular predetermined, limit value, change a sign in one embodiment

or the like;

3) one or more different event processing links or event processing program components or event processing program modules which comprises as input at least one time series of two value input data values or events or input data values changing with events, and comprises as output at least one time series of two value output data values or events or output data values changing with events, in a further development:
changes the value of the output data values or thereby detects or outputs an event if the value of the input data values changes or a start or end of an event is thereby coded;
holds the input value at the occurrence of the last event or the last value change at an input for two-value input data values,

or the like;

and/or

4) one or more different event constellation detection links or event constellation detection program components or event constellation detection program modules which has, as input, at least
one first time series of real, more than two value input data values or detected and/or further or signal-processed sensor signals of the robot application, or
a first time series of two-value input data values or events or input data values changing with events,

as well as
a second time series of real, more than two value input data values or detected and/or further or signal-processed sensor signals of the robot application, or
a second time series of two-value input data values or events or input data values changing with events,

and comprises, as output, at least one time series of two-value output data values or events or output data values changing with events; in one development the value of the output data values changes or thereby detects or outputs an event, if
the input data values of the second time series change their value after the input data values of the first time series have changed their value; in one embodiment, the input data values of the second time series change their value within a predeterminable, in particular predetermined, time period after the input data values of the first time series have changed their value, and/or the input data values of the second time series change their value after the input data values of the first time series have changed their value at least a predeterminable, in particular predetermined, number of times;
the input data values of the second time series comprise a reduction or increase, in particular by a predeterminable, in particular predetermined, level, after the input data values of the first time series comprise changed their value

or the like.

According to one embodiment of the present invention, a programming library for creating a program for controlling and/or monitoring a robot application according to a method described herein comprises one or more programming modules, in particular programming blocks or programming classes, for specifying, in particular configuring, in one embodiment parameterizing, the first link, in one embodiment the first and second links.

According to one embodiment of the present invention, for or when creating a program for controlling and/or monitoring a robot application according to a method described herein, the first link, in one embodiment the first and second links, is predetermined, in particular configured, in one embodiment parameterized, with the aid of such a programming library.

According to one embodiment of the present invention, a system, in particular in terms of hardware and/or software, in particular in terms of programming, is configured to perform a method described herein and/or comprises:
means for determining a time series of first output data values on the basis of a time series of first input data values, a time series of second input data values, a time series of property changes of the first input data values and property changes of the second input data values relative to one another and a predefined first link of the first and second input data values with the output data values, wherein this link comprises a predefined temporal target sequence of property changes of the first input data values and property changes of the second input data values relative to one another; and
means for controlling and/or monitoring the robot application on the basis of the determined first output data values.

In one embodiment, the system or its means comprises:
means for determining a time series of second output data values on the basis of a time series of third input data values and a predefined second link of the third input data values with the second output data values; and
means for controlling and/or monitoring the robot application on the basis of the determined first output data values and the determined second output data values, in particular for determining the first input data values on the basis of the second output data values or the third input data values on the basis of the first output data values.

A system and/or a means within the meaning of the present invention may be designed in hardware and/or in software, and in particular may comprise at least one data-connected or signal-connected, in particular, digital, processing unit, in particular microprocessor unit (CPU), graphic card (GPU) having a memory and/or bus system or the like and/or one or multiple programs or program modules. The processing unit may be designed to process commands that are implemented as a program stored in a memory system, to detect input signals from a data bus and/or to output output signals to a data bus. A storage system may comprise one or a plurality of, in particular different, storage media, in particular optical, magnetic, solid-state, and/or other non-volatile media. The program may be designed in such a way that it embodies or is capable of carrying out the methods described herein, so that the processing unit is able to carry out the steps of such methods and therefore, in particular, is able to control and/or monitor the robot application.

In one embodiment, a computer program product may comprise, in particular be, a storage medium, in particular computer-readable and/or non-volatile, for storing a program or instructions or with a program stored thereon or with instructions stored thereon. In one embodiment, execution of said program or instructions by a system or controller, in particular a computer or an arrangement of a plurality of computers, causes the system or controller, in particular the computer or computers, to carry out a method described herein or one or more steps thereof, or the program or instructions are adapted to do so.

In one embodiment, one or more, in particular all, steps of a method according to the invention are performed completely or partially automatically, in particular by the system or its means.

In one embodiment, the system comprises one or more robots which carry out the robot application(s) or are controlled or monitored for this purpose. Additionally or alternatively, in one embodiment, the system comprises one or more computers for carrying out one or more, in particular all, step(s) of a method according to the invention, in particular in cooperation with the robot(s) or by corresponding communication with the robot(s).

In one embodiment, a temporal (target) sequence of property changes comprises the start or the end or the duration or absence of an event after a start or end, or during a duration or absence of another event, in one embodiment within a predeterminable, in particular predetermined time window, or at least one predeterminable, in particular predetermined number of times after the one event has occurred. In one embodiment, an event within the meaning of the present invention comprises overshooting or undershooting a predeterminable, in particular predetermined, limit value, reaching a local or absolute extremum, in particular local or absolute maximum or local or absolute minimum, decreasing or increasing the value of input data in a predeterminable, in particular predetermined, manner, in particular by at least one predeterminable, in particular predetermined, amount, a change of sign or the like. In one embodiment, in such an event, data values change their value, for example from TRUE to FALSE or from FALSE to TRUE, from 0 to 1 or from 1 to 0 or the like, or such an event is thereby encoded, or such a change in properties is encoded. A property change within the meaning of the present invention can in particular comprise a value change between the two values that encode an event, or an increase or decrease of a sensor signal, in particular a detected and/or processed sensor signal, in a predeterminable, in particular predetermined, manner. in particular by at least one predeterminable, in particular predetermined, amount, or an overshooting or undershooting of a predeterminable, in particular predetermined, limit value by a sensor signal, in particular a detected and/or processed sensor signal.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 illustrates time curves of input and output data for controlling

and/or monitoring a robot application according to one embodiment of the present invention;

FIG. 2 schematically illustrates a program for controlling and/or monitoring the robot application according to one embodiment of the present invention;

FIG. 3 shows a system for controlling and/or monitoring the robot application according to one embodiment of the present invention; and

FIG. 4 depicts a method for controlling and/or monitoring the robot application according to one embodiment of the present invention.

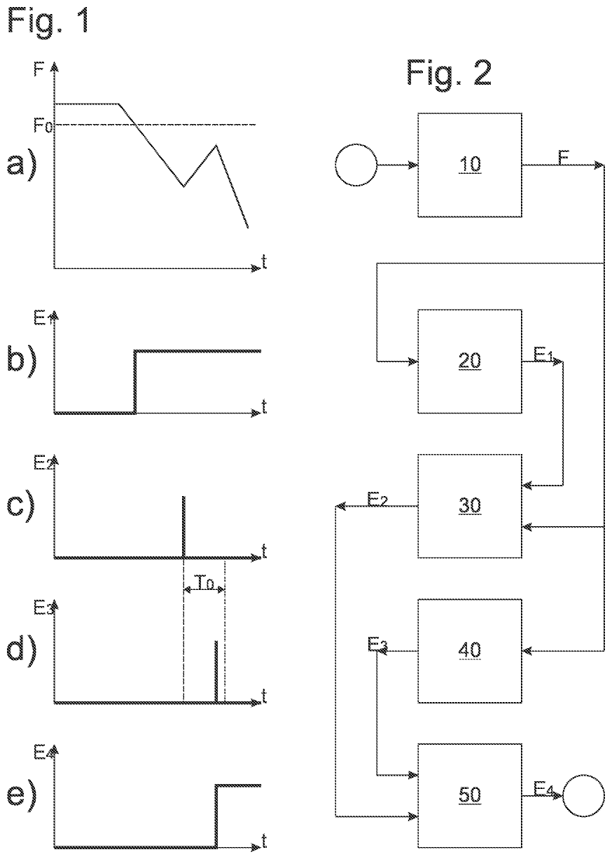

### DETAILED DESCRIPTION

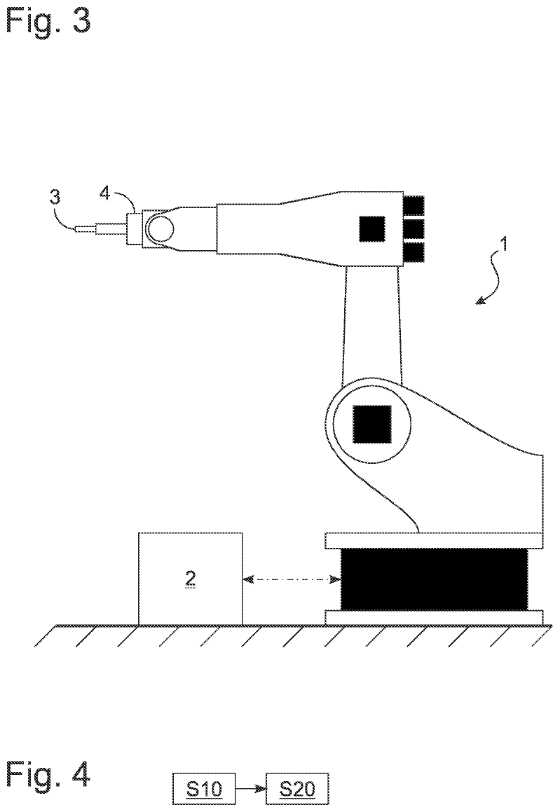

FIG. 3 shows a system for controlling and/or monitoring a robot application according to one embodiment of the present invention. By way of example, a robot controller 2 should control and/or monitor a robot 1 for attaching a clamp 3.

FIG. 2 shows the structure of a program for controlling or monitoring the robot application according to one embodiment of the present invention, FIG. 4 shows a method for controlling and/or monitoring a robot application according to one embodiment of the present invention.

In a first step S10 (see FIG. 4), a first program module 10 receives a time series of real input data values from a sensor 4 which detects a force in the joining direction. On the basis of these input data values, the first program module 10 determines by filtering a time series of real output data values F which are supplied to a second program module 20 as input data values.

The second program module 20 determines therefrom a time series of two-value output data values E₁ which are supplied to a third program module 30.

As long as the input data values F of the second program module 20 fall below a negative limit value F₀, the second program module 20 outputs TRUE values, otherwise FALSE values. In other words, the output data values E₁ change upon an event during the robot application, in this case undershooting or overshooting the limit value F₀, and therefore indicate the start and the end or the duration or absence of the event. The second program module 20 therefore represents an event detection link, or an event detection program component, or an event detection program module.

The output data values F of the first program module 10 are additionally supplied to the third program module 30 as further input data values. From this and the input data values E₁ from the second program module 20, it determines a time series of two-value output data values E₂ which are fed to a fifth program module 50.

If the input data values F of the third program module 30 comprise a local minimum and the input data values E₁ comprise the value TRUE, the third program module 30 outputs a TRUE value, at all other time (point)s, FALSE values.

The output data values F of the first program module 10 are also supplied as input data values to a fourth program module 40. From this, it determines a time series of two-value output data values E₃ which are fed to the fifth program module 50 and comprise the value TRUE if these input data values F comprise a local maximum, and FALSE values at all other times (point)s.

The fifth program module 50 determines a time series of two-value output data values E₄ from its input data values E₂ and E₃, which comprise the value TRUE as soon as the input data values E₃ also comprise a value TRUE within a predetermined time window T₀ after a value TRUE in the time series of the input data values E₂, i.e., the events: “local minimum in F, while F<F₀” and “local maximum in F” occur in this sequence within the time window T₀ or the property changes FALSE→TRUE→FALSE of the input data values E₀ and property change FALSE→TRUE→FALSE of the input data values E₃ comprise this predetermined time sequence.

Accordingly, the fifth program module 50 represents an event constellation detection link or an event constellation detection program component or an event constellation detection program module.

It particularly illustrates an advantage of the present invention: the predetermined time sequence E₃=TRUE in the time period T₀after E₂=TRUE, i.e., the occurrence of a local maximum within a predetermined time after the occurrence of a local minimum, while the limit value F₀ is undershot, can be used to advantageously monitor the correct latching of the clamp 3 or to advantageously control the robot application.

Based on these output data values E₄, the robot controller 2 controls or monitors the robot application, e.g. outputs a monitoring signal if the output data values E₄ do not comprise the value TRUE after a specified joining movement of the robot 1 (monitoring of the robot application), and/or ends the joining movement of the robot 1 as soon as the output data values E₄ comprise the value TRUE (control of the robot application). This is indicated in FIG. 4 by step S20. Similarly, FIG. 4 can also symbolize a method for creating a program according to an embodiment of the present invention, in that the corresponding programming modules are selected in step S10 and linked and configured, in particular parameterized, in step S20.

The above example is greatly simplified for better comprehensibility and illustrates with FIG. 2 equally the use of a programming library or a creation of a program according to an embodiment of the present invention: a programmer can therefore advantageously use the components or blocks 10-50 from the programming library, in particular accordingly link them together and configure, in particular parameterize them.

At the same time, it is clear that more complex robot applications can also be controlled or monitored, or programs can be set up for this purpose. For example, a program(ming) component can be provided or used which outputs an event or correspondingly changes the value of the output data values in a time series if an input signal or input data values since a start event which is encoded by a time series of two-value input data values comprises a predetermined reduction or a predetermined increase, wherein a reset is triggered by a further event that is encoded by a time series of two-value input data values.

Although embodiments have been explained in the preceding description, it is noted that a large number of modifications are possible. It is also noted that the embodiments are merely examples that are not intended to restrict the scope of protection, the applications, and the structure in any way. Rather, the preceding description provides a person skilled in the art with guidelines for implementing at least one embodiment, various changes—in particular with regard to the function and arrangement of the described components—being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Robot
2 Robot controller
3 Clamp
4 Force sensor
10-50 Program(ming) module
F Time series of processed signal values
F₀ Predetermined limit value
E₁-E₄ Time series of data values that change upon an event during the robot application
t Time
T₀ Predetermined time period

What is claimed is:

1. A method for controlling and/or monitoring a robot application, having the steps of:
determining a time series of first output data values on the basis of a time series of first input data values, a time series of second input data values, a time series of property changes of the first input data values and property changes of the second input data values relative to one another and a predefined first link of the first and second input data values with the output data values that comprises a predefined temporal target sequence of property changes of the first input data values and property changes of the second input data values relative to one another; and
controlling and/or monitoring the robot application on the basis of the determined first output data values.

2-14. (canceled)
